(19) United States
(12) Patent Application Publication
(10) Pub. No.: US 2023/0087380 A1
(43) Pub. Date: Mar. 23, 2023

(54) Panel, in Particular a Floor Panel, Ceiling Panel or Wall Panel, and Use of an Additional Layer in a Laminated Multi-Layer Structure of a Panel

(71) Applicant: Northann Building Solutions LLC, Sacramento, CA (US)

(72) Inventor: Lin LI, Elk Grove, CA (US)

(21) Appl. No.: 17/791,650

(22) PCT Filed: Jan. 11, 2021
(86) PCT No.: PCT/IB2021/050165

§ 371 Date: Jul. 8, 2022

(30) Foreign Application Priority Data
Jan. 9, 2020 (NL) 2024632

(51) Int. Cl. E04F 13/08; E04F 15/10; E04F 15/02; E04F 13/18; C08L 75/06

(52) U.S. Cl. CPC E04F 13/0866; E04F 15/107; E04F 13/0871; E04F 13/0894; E04F 15/02038; E04F 13/18; E04F 15/105; C08L 75/06

(57) ABSTRACT

Provided is a panel, in particular a floor panel, ceiling panel, or wall panel, having a laminated multi-layer structure which includes a core layer, a decorative layer above the core layer, a transparent top layer above the decorative layer, and an intermediate layer situated between the decorative layer and the top layer. The intermediate layer is transparent, and made from a protective material which includes a polyurethane composition which is the reaction product of a polyester polyol, a polyether polyol, and an isocyanate. The polyurethane composition is a thermoset polymer material. Also provided is a use of an additional layer in a laminated multi-layer structure of a panel in particular a floor panel, ceiling panel, or wall panel. The additional layer is transparent, and is made from a protective material which includes a polyurethane composition which is the reaction product of a polyester polyol, a polyether polyol, and an isocyanate. The polyurethane composition is a thermoset polymer material.

### CROSS-REFERENCE TO RELATED APPLICATIONS

This application is the United States national phase of International Application No. PCT/IB2021/050165 filed Jan. 11, 2021, and claims priority to The Netherlands Patent Application No. 2024632 filed Jan. 9, 2020, the disclosures of which are hereby incorporated by reference in their entirety.

### BACKGROUND OF THE INVENTION

### Field of the Invention

The present invention according to a first aspect, relates to a panel in particular a floor panel, ceiling panel or wall panel. In a second aspect, the invention relates to the use of an additional layer in a laminated multi-layer structure of a panel.

### Description of Related Art

In the field of building, the use of panels which are based on a laminated multi-layer structure is generally known. They have proven highly versatile for covering surfaces, such as a floor, a wall and a ceiling. In particular it is attractive to use a laminated multi-layer structure which comprises:
a core layer,
a decorative layer above the core layer,
a transparent top layer above the decorative layer.

Recent developments have been directed to a specific modification of the top side of the top layer of such a panel once the multi-layered structure is formed, which is referred to as embossing. In embossing, the top side of the top layer is provided with a relief which mimics a natural top surface such as perceived from wooden panels. A special way of embossing is embossing in register, which provides a relief that corresponds with the decorative layer, for instance corresponding with a decorative image of a wooden panel surface with a grain pattern.

In producing such panels, the embossing of the top layer may be executed by several techniques, such as compression, milling or chemical etching of the top layer. After the relief is embossed on the top surface, further finishing steps may be needed such as finely grinding or sanding of the embossed surface.

It has been found that during embossing and/or finishing of the top layer of a panel, the integrity or the appearance of the underlying decorative layer may be negatively affected, and may even be damaged.

### SUMMARY OF THE INVENTION

It is therefore an objective of the invention to further secure that in producing a laminated multi-layered panel such as defined above, it is prevented that the embossing and finishing steps for the top layer could alter the integrity or appearance of the underlying decorative layer.

The present invention achieves the above objective by the provision of
a panel, in particular a floor panel, ceiling panel or wall panel,

having a laminated multi-layer structure which comprises
a core layer,
a decorative layer above the core layer,
a transparent top layer above the decorative layer, and
an intermediate layer situated between the decorative layer and the top layer,
   which intermediate layer is transparent, and substantially is made from a protective material which comprises a polyurethane composition which is the reaction product of a polyester polyol, a polyether polyol and an isocyanate.

It has been found that the specific protective material of the intermediate layer has a sufficiently high hardness to protect the decorative layer against any abrasion or indentation during the embossing and finishing of the top layer of the panel.

In the context of the panel according to the invention, the terms ‘above’ and ‘upper’ relate to the direction to which the panel faces once it is applied on a floor or likewise. The term ‘substantially’ encompasses that at least 75 wt. %, and preferably at least 90 wt. %, most preferably 100 wt. %, of the intermediate layer is made from the protective material.

The decorative layer may contain a (printed) decorative image on the upper side of the decorative layer which is visible when the panel is used as a floor panel, ceiling panel, or wall panel. The intermediate layer is of a satisfactorily transparent quality so that the visibility of the decorative image is not affected by the intermediate layer.

In the panel according to the invention, it is typical that the respective layers of the laminated multi-layer structure are directly or indirectly attached onto each other.

Preferably the polyurethane composition of the panel of the invention is a thermoset polymer material, and in particular the polyurethane composition is a cross-linked polymer.

The thermoset polymer material is in the art also known as a hot-melt adhesive, wherein thermosetting typically occurs over a heat trajectory of 100-160° C.

When producing the panel, the intermediate layer could be applied in a hot-melt state in order to be solidly attached to a neighbouring layer of the panel.

In the panel according to the invention, the polyester polyol preferably has a weight average molar mass Mw in the range of 500 to 20,000, and comprises preferably a polyester polyol having linear monomers of 5 to 8 carbon atoms.

The polyester polyol may include a polyester glycol, such as for instance a polyester formed by reacting hexane diol with adipic acid.

Further in the panel according to the invention, the polyether polyol preferably has a weight average molar mass Mw in the range of 400 to 10,000, and comprises preferably a polyether polyol having branched monomers of 2 to 5 carbon atoms.

The polyether polyol may include a polyether glycol, such as polypropylene glycol.

It is in particular preferred in the panel according to the invention, that the isocyanate is a di-isocyanate and/or tri-isocyanate, preferably methylene diphenyl di-isocyanate.

With respect to the protective material, the following preferred weight percentages apply:
the protective material contains 5-50 wt. % reacted polyester polyol;
the protective material contains 10-40 wt. % reacted polyether polyol;
the protective material contains 5-20 wt. % reacted isocyanate.

It is furthermore preferred that the protective material comprises a filler material as an additive, such as microfibers and/or alumina, preferably in a range of 0.2-5 wt. % with respect to the protective material.

This type of filler material further contributes to the required hardness of the protective material, and thus enhances the anti-abrasive properties of the protective material.

In the panel according to the invention, it is preferred that the intermediate layer is directly attached onto the decorative layer and/or onto the top layer.

As such, the required visibility of the decorative layer can be accomplished most expediently.

In the context of the panel according to the invention, it is preferred that the top side of the top layer is embossed with a relief, which relief preferably corresponds to the decorative image of the decorative layer.

It is furthermore preferred that in the panel according to the invention, the intermediate layer has a grammage of 20 up to 80 g/m2.

Such a grammage determines the thickness of the intermediate layer to such a range, that an optimum protection for the decorative layer as well as an optimum visibility of the decorative layer is achieved.

It is advantageous in the panel according to the invention that the intermediate layer is colorless. As such, the appearance of the decorative layer is not altered by any hue on the top side of the panel.

It is preferred in the panel according to the invention that the intermediate layer has a relatively low reflectance of 4%, 3%, 2% or lower.

Such an intermediate layer has a reflectance value that is comparable to glass, or may even be lower than glass. The reflectance value is also referred to in the field as the reflection coefficient of a material.

By virtue of such a reflectance value of the intermediate layer, an optimum visibility of the underlying decorative layer is achieved, because the amount of transmitted light is relatively high while only small amounts of light are reflected.

In the context of the invention, it is further preferred that the intermediate layer has a relatively low refractive index, preferably between 1.0 and 1.3.

Further preferred features of the panel according to the invention include:
the panel comprises a backing layer attached to a lower side of the core layer;
the panel thickness is between 3 and 10 mm;
the panel is flat and has a rectangular contour, comprising four side edges.

In a further preferred embodiment, the panel according to the invention, comprises a first panel edge comprises a first coupling profile, and a second panel edge, preferably opposite to the first panel edge, comprising a second coupling profile being designed to engage by interlocking with said first coupling profile of an adjacent panel, both in horizontal direction and in vertical direction, wherein the first coupling profile and the second coupling profile are preferably configured such that two of such panels can be coupled to each other by means of a lowering movement.

Such a panel allows for adequately covering a flat surface with a multitude of interconnected panels and thus achieving a covering of panels that is robust as a whole.

Additionally or alternatively to the above first and second coupling profiles, the panel may further comprise at least one third coupling profile and at least one fourth coupling profile located respectively at a third panel edge and a fourth panel edge, wherein the third coupling profile comprises:
a sideward tongue extending in a direction substantially parallel to the upper side of the core,
at least one second downward flank lying at a distance from the sideward tongue, and
a second downward groove formed between the sideward tongue and the second downward flank,
   wherein the fourth coupling profile comprises:
a third groove configured for accommodating at least a part of the sideward tongue of the third coupling profile of an adjacent panel, said third groove being defined by an upper lip and a lower lip, wherein said lower lip is provided with an upward locking element,
   wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

In a second aspect, the invention relates to the use of an additional layer in a laminated multi-layer structure of a panel in particular a floor panel, ceiling panel or wall panel,
wherein the additional layer is preferably transparent, and is substantially made from a protective material which comprises a polyurethane composition which is the reaction product of a polyester polyol, a polyether polyol and an isocyanate.

Such a use of an additional layer forms a protective layer, which protects the laminated structure of the panel to any high-impact techniques which are performed during the production of a panel, such as during embossing of a relief on a top layer of the panel.

In the use of an additional layer according to the invention, it is preferred that the polyurethane composition is a thermoset polymer material, wherein preferably the polyurethane composition is a cross-linked polymer.

Such preferred types of polyurethane composition have a suitable hardness for the intended function of the additional layer, i.e. a hardness which is sufficiently high to protect the laminated multi-layer structure against any abrasion or indentation during the production of the panel.

In general, the use according to the invention may include preferred features relating to the panel and the respective additional layer, which features correspond to the preferred features already described above in view of the panel and the respective intermediate layer according to the first aspect of the invention.

In particular it is preferred in the use of an additional layer according to the invention, that the laminated multi-layer structure of the panel comprises:
a core layer,
a decorative layer above the core layer,
a transparent top layer above the decorative layer, and the additional layer is applied as an intermediate layer situated between the decorative layer and the top layer.

As already explained above, such an intermediate layer is most effective in protecting the decorative layer against any abrasion or indentation during the production of the panel.

In general, it is preferred that the use of an additional layer according to the second aspect of the invention is applied in a panel according to the first aspect of the invention.

### Example

### BRIEF DESCRIPTION OF THE DRAWINGS

The invention will be further elucidated by specific preferred embodiments which are shown in the appended figures, wherein:

FIG. 1 shows a cross-section of a laminated multi-layer structure of the panel according to the invention;

FIGS. 2 and 3 show in cross-section two types of engaging coupling profiles suitable for a panel according to the invention.

### DESCRIPTION OF THE INVENTION

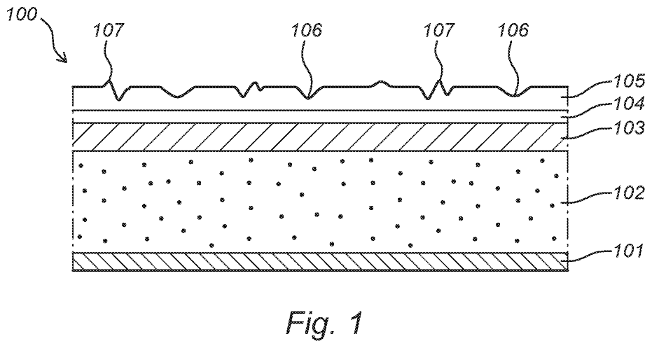

FIG. 1 shows schematically a cross-section of a laminated multi-layer structure of a panel 100, which is constituted from multiple layers which are directly connected to each other. These layers include a backing layer 101, a core layer 102, a decorative layer 103 provided with a decorative image, an intermediate layer 104 and an embossed top layer 105. The embossed top layer contains depressions 106 and elevations 107, so that a relief is formed on the top surface of the top layer which corresponds to the pattern of the decorative image that is facing upwards from the decorative layer 105. The intermediate layer 104 is formed from a protective material in accordance with the invention, and is transparent and colorless.

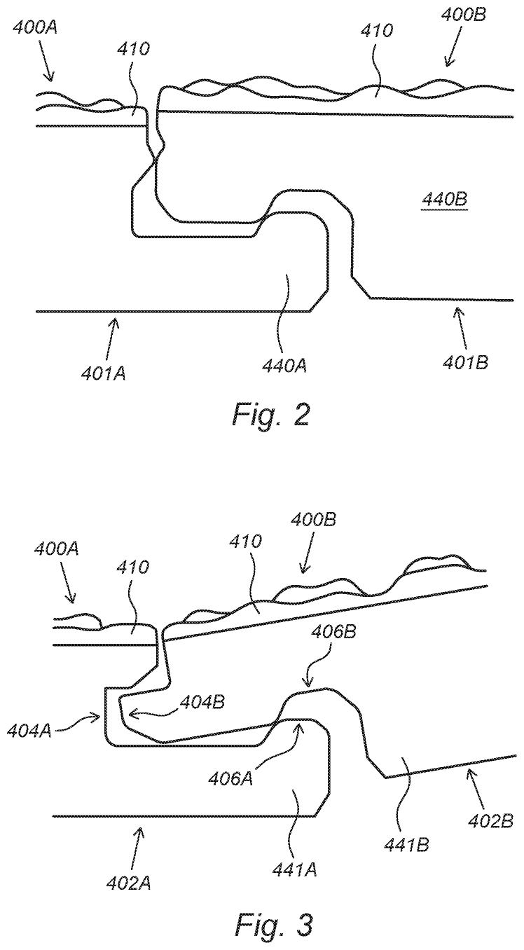

FIGS. 2 and 3 show two types of engaging coupling profiles 401A, 401B resp. 402A, 402B, of two interconnecting panels 400A, 400B according to the present invention. The panels 400A and 400B comprise an embossed top layer 410. As a whole, each panel has a laminated multi-layer structure in accordance with FIG. 1 (which is however not further shown in detail in FIGS. 2 and 3).

FIG. 2 shows panels 400A and 400B, which respectively comprise a first panel edge 440A comprising a first coupling profile 401A, and a second panel edge 440B opposite to the first panel edge 440A, comprising a second coupling profile 401B being designed to engage by interlocking with said first coupling profile 401A of an adjacent panel, both in horizontal direction and in vertical direction, wherein the first coupling profile 401A and the second coupling profile 401B are configured such that two of such panels can be coupled to each other by means of a lowering movement.

FIG. 3 shows panels 400A and 400B, which respectively comprise a third coupling profile 402A and a fourth coupling profile 402B located respectively at a third panel edge 441A and a fourth panel edge 441B. The third coupling profile 402A and the fourth coupling profile 402B are configured such that the two panels 440A, 440B can be coupled to each other by means of a turning movement, wherein, in coupled condition at least a part of a sideward tongue 404B of a first panel is inserted into a groove 404A of an adjacent, second panel, and wherein at least a part of an upward locking element 406A of said second panel is inserted into a second downward groove 406B of said first panel.

It is noted that the invention is not limited to the examples shown and described above, but that numerous variants are possible within the scope of the attached claims that will be clear to a person skilled in the art.

The verb “comprise” and conjugations thereof used in the description are understood to mean not only “comprise”, but are also understood to mean the phrases “contain”, “substantially consist of”, “formed by” and conjugations thereof.

1. A panel, in particular a floor panel, ceiling panel, or wall panel,
having a laminated multi-layer structure which comprises:
a core layer,
a decorative layer above the core layer,
a transparent top layer above the decorative layer, and
an intermediate layer situated between the decorative layer and the top layer,
which intermediate layer is transparent, and made from a protective material which comprises a polyurethane composition which is the reaction product of a polyester polyol, a polyether polyol, and an isocyanate, and wherein the polyurethane composition is a thermoset polymer material.

2. The panel according to claim 1, wherein the respective layers of the laminated multi-layer structure are directly or indirectly attached onto each other.

3. The panel according to claim 1, wherein the polyurethane composition is a cross-linked polymer.

4. The panel according to claim 1, wherein the polyester polyol has a weight average molar mass Mw in the range of 500 to 20,000, and comprises preferably a polyester polyol having linear monomers of 5 to 8 carbon atoms.

5. The panel according to claim 1, wherein the polyether polyol has a weight average molar mass Mw in the range of 400 to 10,000, and comprises preferably a polyether polyol having branched monomers of 2 to 5 carbon atoms.

6. The panel according to claim 1, wherein the isocyanate is a di-isocyanate and/or tri-isocyanate, preferably methylene diphenyl di-isocyanate.

7. The panel according to claim 1, wherein the protective material contains 5-50 wt. % reacted polyester polyol.

8. The panel according to claim 1, wherein the protective material contains 10-40 wt. % reacted polyether polyol.

9. The panel according to claim 1, wherein the protective material contains 5-20 wt. % reacted isocyanate.

10. The panel according to claim 1, wherein the protective material comprises a filler material as an additive, such as microfibers and/or alumina, preferably in a range of 0.2-5 wt. % with respect to the protective material.

11. The panel according to claim 1, wherein the intermediate layer is directly attached onto the decorative layer and/or onto the top layer.

12. The panel according to claim 1, wherein the top side of the top layer is embossed with a relief, which relief preferably corresponds to the decorative image of the decorative layer.

13. The panel according to claim 1, wherein the intermediate layer has a grammage of 20 up to 80 g/m2.

14. The panel according to claim 1, wherein the intermediate layer is colorless.

15. The panel according to claim 1, wherein the intermediate layer has a relatively low reflectance of 4%, 3%, 2% or lower.

16. The panel according to claim 1, comprising a first panel edge which comprises a first coupling profile, and a second panel edge, preferably opposite to the first panel edge, comprising a second coupling profile being designed to engage by interlocking with said first coupling profile of an adjacent panel, both in horizontal direction and in vertical direction, wherein the first coupling profile and the second coupling profile are preferably configured such that two of such panels can be coupled to each other by means of a lowering movement.

17. The panel according to claim 1, comprising at least one third coupling profile and at least one fourth coupling profile located respectively at a third panel edge and a fourth panel edge, wherein the third coupling profile comprises:
a sideward tongue extending in a direction substantially parallel to the upper side of the core,
at least one second downward flank lying at a distance from the sideward tongue, and
a second downward groove formed between the sideward tongue and the second downward flank,
wherein the fourth coupling profile comprises:
a third groove configured for accommodating at least a part of the sideward tongue of the third coupling profile of an adjacent panel, said third groove being defined by an upper lip and a lower lip, wherein said lower lip is provided with an upward locking element,
wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

18. An additional layer in a laminated multi-layer structure of a panel in particular a floor panel, ceiling panel, or wall panel, wherein the additional layer is transparent, and is made from a protective material which comprises a polyurethane composition which is the reaction product of a polyester polyol, a polyether polyol, and an isocyanate, and wherein the polyurethane composition is a thermoset polymer material.

19. Additional layer according to claim 18, wherein the polyurethane composition is a cross-linked polymer.

20. Additional layer according to claim 18, wherein the laminated multi-layer structure of the panel comprises:
a core layer,
a decorative layer above the core layer,
a transparent top layer above the decorative layer,
and the additional layer is applied as an intermediate layer situated between the decorative layer and the top layer.

21. (canceled)
